(19) United States
(12) Patent Application Publication
(10) Pub. No.: US 2005/0077155 A1
(43) Pub. Date: Apr. 14, 2005

(54) Flashing joystick

(76) Inventor: Lobo Wang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/680,123

(22) Filed: Oct. 8, 2003

(51) Int. Cl. G09G 5/08

(52) U.S. Cl. 200/6 A; 345/161

(57) ABSTRACT

A flashing joystick comprises a power supply which supplying power to the joystick; a key-press group used for users controlling in order to send control signal to game machine to manipulate a game role; a signal transfer device which sending and receiving signal between the joystick and the game machine; a microprocessor which receives control signal from the key-press group and sends it to the game machine by the a signal transfer device so as to manipulate the game scenario progress; at least one LED (Light-Emitting Diode) are joined with the joystick circuit so that emitting flashing light when the circuit electrified; and a joystick shell which is made of penetrating-light material for penetrating flashing light produced by the LED out of the joystick shell. The present invention will emit florid flashing light while the playing course, and the player will get better playing results.

### FIELD OF THE INVENTION

The present invention relates generally to a game machine joystick and more particularly to a flashing joystick which can emit flash during playing electrical game on the game machine.

### BACKGROUND OF THE INVENTION

Along with the science and technology developing, the hardware configuration of the game machine are enhanced day by day. From early Family Computer produced by Nintendo, to the PlayStation produced by Sony and the Xbox produced by Microsoft, the game machines possess entertainment ability from strength to strength and thus provide people with more happiness.

In the course of developing, the game machine designers always consider how to improve the joystick to get better game effects. Designs of the joysticks also involved from the early tabulate game machine controller (such as Family Computer produced by Nintendo) to the PlayStation controller which has extra two handle, to the joysticks which support Force-Feed-back standard such as PlayStation 2 and Xbox.

However, these designs consider touch sense of the player more, but the players want more novel products.

### SUMMARY OF THE INVENTION

An object of the present invention is to provide a flashing joystick which can emit light during player playing game so as to that produce better game effects.

In order to achieve the above object, the present invention provides a flashing joystick comprising a power supply which supplies working power for the flashing joystick, a key-press group used for user handling which sends out control signal to the game machine so as to control the game scenario, a signal transfer device used for transferring control signals between the joystick and the game machine, a microprocessor which receives control signals from the key-press group and then sends it to the game machine through the signal transferring device so as to control the game scenario progressing, at least one light emitting element linked with the joystick circuit for emitting light when the circuit electrified, and a joystick shell which penetrates light so that the light produced by said light emitting element is emitted outside.

As described above, the present invention will emit florid light during the game playing and thus player will get better game enjoyment.

### BRIEF DESCRIPTION OF THE DRAWINGS

The present invention will be apparent to those skilled in the art by reading the following description of preferred embodiments thereof, with reference to the attached drawings, in which:

FIG. 1 is a block circuit diagram of the preferred embodiment of the present invention;

FIG. 2 shows a perspective view of the preferred embodiment of the present invention;

### DETAILED DESCRIPTION OF PREFERRED EMBODIMENTS OF THE INVENTION

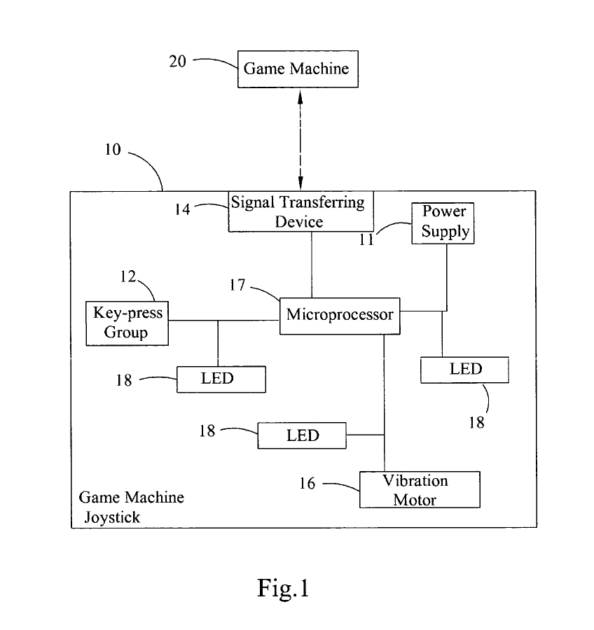

Please refer to FIG. 1, the present invention comprises a power supply device 11, a key-press group 12, a signal transferring device 14, a vibration motor 16, a microprocessor 17, a joystick shell 30 and flashing element. In the present embodiment, the flashing element may be LED (Light-Emitting Diode) 18, and the products which implements the invention will get better effects when the flashing element is Blinking LED.

The power supply 11 provides working power for the game machine joystick 10. The power supply 11 may be a battery or other power supply 11 which gets power from game machine through wire.

The key-press group 12 which used for user handling is placed outside the joystick shell 30. The key-press group 12 will send out control signal to the game machine so as to control the game scenario.

The signal transferring device 14 is used for transferring control signals between the joystick and the game machine. The signal transferring device may transfer signal through wire or wireless.

The microprocessor 17 will receive control signals from the key-press group 12 and then send it to the game machine through the signal transferring device 14 so as to control the game scenario progressing. Moreover, the microprocessor 17 will receive corresponding signal from the signal transferring device 14 which comes from the game machine and then send it to the vibration motor 16.

The vibration motor 16 will be driven by receiving the signals from the microprocessor 17.

At least one LED 18 is linked with circuits which located between the power supply 11 and the microprocessor 17, or between the key-press group 12 and the microprocessor 17, or between the vibration motor 16 and microprocessor 17. While these circuits electrified, the LED 18 will be lighted. Furthermore, the LED 18 linked with circuit may be various colors according to various effects.

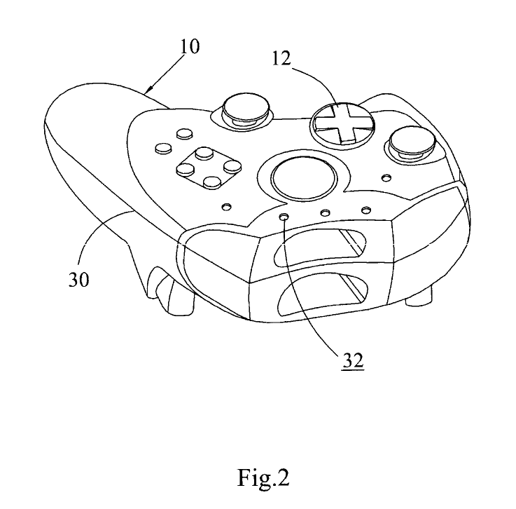

Please refer to FIG. 2, the joystick shell 30 has some light-emitting-holes 32 arranged on its surface, these light-emitting-holes 32 help flashing light produced by the LED 18 outside of the joystick shell 30. And, it will produce the same effect that the joystick shell 30 is made of penetrating-light material.

Referring to FIG. 1 and FIG. 2, when players want to start games, the game machine and the joystick will be turned on at first, and the LED 18 linked with the circuit which located between the power supply 11 and the microprocessor 17 will induce the current passing through and thus will be lighted. In the course of playing games, while players pressing the key-press group 12, the control signals will be transmitted into the microprocessor 17, and the LED 18 linked with the circuits which located between the key-press group 12 and the microprocessor 17 will be lighted. When the game progressing in some drastic scenario, for example, in some shooting games, when the game role throws a grenade, the game machine will transmit a corresponding control signal to the microprocessor 17 by the signal transfer device 14, the microprocessor 17 will then transmit the signal to the vibration motor 16 and the vibration motor 16 will be driven so as to simulate a actual vibration effects (these vibration effect must fit some specific games). At the same time, the LED 18 linked with the circuits which located between the vibration motor 16 and microprocessor 17 will induce the current and will emit flash. Because the joystick shell 30 is made of penetrating-light material or has some light-emitting-holes 32 placed on its surface, the flash produced by the LED 18 will emit outside the joystick shell 30. Such arrangements will emit florid flashing light while the playing course, and the player will get better playing results. For attaining various effects, other type lighting elements can be used in the joystick, such as using red LED, blue LED and green LED at the same time. Furthermore, designers may add some transparent films decorated with various patterns on the light-emitting-holes 32, or embed the films in the transparent joystick shell 30. While the light emitting, various patterns will be seen so as to increasing the florid game effects.

This invention has been described with reference to specific embodiments, this description is not to be construed in a limiting sense. For example, those skilled in the art will recognize modifications and alterations that may be made to the embodiments illustrated herein. However, it is contemplated that such modifications can be made without departing the scope and spirit of the invention as defined in the following claims. For example, to change the linking location of the lighting element should be the claim scope of the present invention.

1. A flashing joystick used for game machine comprising:
a power supply which supplies working power for the flashing joystick;
a key-press group used for user handling which sends out control signal to the game machine so as to control the game scenario;
a signal transfer device used for transferring control signals between the joystick and the game machine;
a microprocessor which receives control signals from the key-press group and then send it to the game machine through the signal transferring device so as to control the game scenario progressing;
at least one light emitting element linked with the joystick circuit for emitting light when the circuit electrified; and
a joystick shell which can penetrate light so that the light produced by said light emitting element is emitted outside.
The flashing joystick as claimed in claim 1, wherein said light emitting element is led:

2. The flashing joystick as claimed in claim 2, wherein said LED is Blinking LED.

3. The flashing joystick as claimed in claim 1, wherein said joystick shell has at least one light-emitting-holes arranged on its surface which allows the light produced by the LED penetrating outside of the joystick shell.

4. The flashing joystick as claimed in claim 4, further comprising a transparent film with decorated pattern placed on the light-emitting-holes.

5. The flashing joystick as claimed in claim 1, wherein the joystick shell is made of penetrating-light material.

6. The flashing joystick as claimed in claim 6, wherein the transparent film with pattern is embedded in the joystick shell.

7. The flashing joystick as claimed in claim 1, wherein the light emitting element linked with circuit which located between located the power supply and the microprocessor.

8. The flashing joystick as claimed in claim 1, wherein the light emitting element linked with circuit which located between the key-press group and the microprocessor.

9. The flashing joystick as claimed in claim 1, wherein the light emitting element linked with circuit which located between the vibration motor and microprocessor.
